(19) United States
(12) Patent Application Publication
(10) Pub. No.: US 2011/0274768 A1
(43) Pub. Date: Nov. 10, 2011

(54) ANTIBACTERIAL WATER TREATMENT AGENT

(76) Inventor: Kenji NAKAMURA, Osaka-shi (JP)

(21) Appl. No.: 13/152,118

(22) Filed: Jun. 2, 2011

(30) Foreign Application Priority Data
Dec. 8, 2010 (JP) 2010-273186

(51) Int. Cl. A01N 59/16; A01P 1/00

(52) U.S. Cl. 424/618

(57) ABSTRACT

An antibacterial water treatment agent constituted by polyethylene containing silver zeolite is characterized in that the silver zeolite has a type-A crystalline structure and is contained by a range of 10 to 30 percent by weight, and that the aforementioned antibacterial water treatment agent is a porous body having continuous holes formed from the silver zeolite to the surface of the porous body and these continuous holes in the porous body are passages of vaporized crystallization water contained in the above silver zeolite.

### BACKGROUND OF THE INVENTION

1. Field of the Invention

The present invention relates to an antibacterial water treatment agent constituted by polyethylene containing silver zeolite. To be specific, the present invention relates to an antibacterial water treatment agent containing silver zeolite that, being present on the surface and also inside the agent, elutes silver ions from the surface and inside of the agent to demonstrate antibacterial action against bacteria that contaminate water used in various applications such as water servers, water tanks, air-conditioners, washing tubs, drain mechanisms for sinks, drain piping facilities, water-based washing machines, and the like.

2. Description of the Related Art

Silver zeolite is most widely used in suppressing the breeding of bacteria that contaminate water used in various applications as mentioned above, for its high level of safety, wide antibacterial spectrum, excellent durability, and absence of generation of resistant bacteria. However, silver zeolite exists in powder form, which makes it difficult to handle silver zeolite as it is washed away by water. To solve this problem, antibacterial water treatment agents are available on the market, which are made by impregnating resin with silver zeolite and then shaping it into plastic pellets. Among these plastic pellets, the antibacterial composition described in Patent Literature 1 is known. This antibacterial composition is obtained by mixing silver zeolite and bentonite for 3 to 4 hours and forming the mixture into pellets, after which the pellets are sintered for 4.5 hours at 510 to 520° C. (refer to Patent Literature 1). However, this antibacterial composition presents a problem in that, although it demonstrates antibacterial action due to silver zeolite present on its surface, silver zeolite contained in the composition cannot demonstrate antibacterial action, which results in the antibacterial action of this antibacterial composition lasting for only a short period of 1 month or so. Even if the content of silver zeolite is increased, silver zeolite in the composition does not contribute to antibacterial action, so the antibacterial action of the composition will last for 2 months or so, with silver zeolite in the composition not demonstrating any antibacterial action.

The antibacterial resin molded product described in Patent Literature 2 was proposed to solve this problem. This antibacterial resin molded product is a polyolefin resin containing silver inorganic antibacterial agent (silver zeolite) or halogen salt of alkali metal or alkali earth metal, where it is reported that when this antibacterial resin molded product was immersed in a storage tank of a water server to release silver ions into stored water, breeding of water bacteria could be suppressed for 3 months (refer to Patent Literature 2, especially Table 4).

### PATENT LITERATURES

[Patent Literature 1] Japanese Patent Laid-open No. Sho 60-100504
[Patent Literature 2] Japanese Patent Laid-open No. 2008-174576

### SUMMARY OF THE INVENTION

As for the antibacterial resin molded product described in Patent Literature 2, silver zeolite and halogen salt are present at different locations, so fine voids that generate after halogen salt has dissolved do not serve as passages through which to elute silver ions, unless silver zeolite is present in theses voids. For this reason, a majority of silver zeolite does not contact water and thus does not exhibit effective antibacterial action, and consequently the antibacterial action of the above antibacterial resin molded product is likely to last for 4 months or so. As just explained, the antibacterial resin molded product described in Reference Literature 2 prevents a lot of silver zeolite contained in the resin from exhibiting antibacterial action, meaning that expensive silver zeolite is not effectively utilized and remains useless.

The present invention was developed in light of the aforementioned problem of the prior art and it is the object of the present invention to provide an antibacterial water treatment agent constituted by polyethylene containing silver zeolite that demonstrates a high level of safety, etc., wherein said antibacterial water treatment agent allows for effective utilization of not only silver zeolite present on its surface, but also silver zeolite contained inside.

Traditionally, silver zeolite of type-A crystalline structure contained in plastic pellets (hereinafter referred to as “type-A silver zeolite”) is dried at 250° C. However, type-A silver zeolite used in the antibacterial water treatment agent proposed by the present invention is dried at 110° C. so that its skeleton contains 16.8 percent by weight of crystallization water. Because of this, water steam generates from the extrusion machine during the molding process and plastic pellets become white. By focusing on this characteristic, an attempt was made to introduce polyolefin resin pellets and type-A silver zeolite including crystallization water into the extrusion machine to perform pelletization. Here, a technical commonsense in this industry is to dry the above pellets at 250° C. to remove moisture before introducing them into the extrusion machine. This is because when pellets containing moisture are introduced into the extrusion machine, the quality of formed pellets will become lower due to the presence of moisture, thereby causing the injection molded product made with these pellets to exhibit low quality. For this reason, it is considered a taboo among experts to introduce moisture-containing pellets, filler, etc., into the extrusion machine to form plastic pellets.

Because of this, the attempt to form plastic pellets by introducing the type-A silver zeolite into the extrusion machine encountered tremendous difficulties. However, the inventor daringly introduced the aforementioned type-A silver zeolite into the extrusion machine and formed the aforementioned molded product, and found that the molded product was a porous body having continuous holes formed on its surface from type-A silver zeolite, where a large amount of silver ions could elute through these continuous holes in the porous body. Based on this discovery, the inventor completed the present invention.

To be specific, the present invention is described as follows.

The antibacterial water treatment agent pertaining to Embodiment 1 is an antibacterial water treatment agent constituted by polyethylene containing silver zeolite, characterized in that the silver zeolite has a type-A crystalline structure and is contained by a range of 10 to 30 percent by weight, and that the antibacterial water treatment agent is a porous body having continuous holes formed from the silver zeolite to the surface of the porous body and these continuous holes in the porous body are formed by crystallization water (i.e., tracks of vaporized crystallization water) contained in the above silver zeolite.

The antibacterial water treatment agent pertaining to Embodiment 2 is characterized in that the MFR (Melt Flow Rate) of the aforementioned polyethylene is in a range of 7 to 30 g per 10 minutes and that its melting point is in a range of 120 to 140° C.

The antibacterial water treatment agent pertaining to Embodiment 3 is characterized in that the silver support ratio of the aforementioned silver zeolite is in a range of 0.5 to 5.0%.

The antibacterial water treatment agent pertaining to Embodiment 4 is characterized in that the concentration of silver ions produced via acid dissolution from silver zeolite in the aforementioned porous body is in a range of 1.3 to 64 ppm.

The antibacterial water treatment agent pertaining to Embodiment 5 is characterized in that the amount of silver ions produced via acid dissolution from silver zeolite in the aforementioned porous body is in a range of 27 to 1277 mg.

The antibacterial water treatment agent pertaining to Embodiment 6 is characterized in that the utilization ratio of silver ions produced via acid dissolution from silver zeolite in the aforementioned porous body is in a range of 53 to 85%.

The antibacterial water treatment agent pertaining to Embodiment 7 is characterized in that the aforementioned amount of acid dissolution silver ions in the porous antibacterial water treatment agent when containing silver zeolite at 2.2% in silver support ratio is 12 times the amount of acid dissolution silver ions in other antibacterial water treatment agents containing silver zeolite at 2.5% in silver support ratio.

The antibacterial water treatment agent pertaining to Embodiment 8 is characterized in that the aforementioned polyethylene is low-density polyethylene or high-density polyethylene.

The antibacterial water treatment agent pertaining to Embodiment 9 is characterized in that the aforementioned antibacterial water treatment agent further comprises glass beads in a range of 10 to 30 percent by weight.

The antibacterial water treatment agent proposed by the present invention is a porous body having continuous holes formed on its surface from silver zeolite, and because the concentration of silver ions produced via acid dissolution from silver zeolite contained in the water treatment agent is in a range of 1.3 to 64 ppm and the amount of acid dissolution silver ions is in a range of 27 to 1277 mg, silver ions can be diffused over a wide range, which is useful in various applications such as water servers, water tanks, air-conditioners, washing tubs, drain mechanisms for sinks, drain piping facilities, water-based washing machines, and the like. Also, the amount of antibacterial water treatment agent to be immersed can be increased or decreased to meet any application.

In addition, the antibacterial water treatment agent proposed by the present invention has silver ions from silver zeolite contained in the water treatment agent utilized by a range of 53 to 85%, which ensures effective utilization of expensive silver zeolite and greater economy.

Furthermore, the amount of acid dissolution silver ions in the antibacterial water treatment agent proposed by the present invention is 12 times the amount of silver ions in other commercial products, which means that a much larger amount of silver ions can be eluted compared to other commercial products containing the same amount of silver zeolite, and consequently the antibacterial action will last longer.

Moreover, when the antibacterial water treatment agent proposed by the present invention is immersed in a storage tank of a water server, water tank, or other water container, glass beads can be contained by a range of 10 to 30 percent by weight in the treatment agent and then the treatment agent is immersed in water to cause silver ions to elute by means of precipitation.

### BRIEF DESCRIPTION OF THE DRAWINGS

FIG. 1 is an electron micrograph of ×40 magnification, showing a lateral cross-section of a pellet of antibacterial water treatment agent FIG. 2 is an electron micrograph of ×40 magnification, showing a side face of a pellet of antibacterial water treatment agent

### DETAILED DESCRIPTION OF THE PREFERRED EMBODIMENT

First, the method for manufacturing the antibacterial water treatment agent is explained, followed by an explanation of the antibacterial water treatment agent.

In the following explanation, all percent values used in connection with the antibacterial water treatment agent, etc., are percents by weight.

An overview of the method for manufacturing the antibacterial water treatment agent proposed by the present invention is as follows.

Silver zeolite is generally aluminosilicate having a three-dimensional skeletal structure, expressed by a general formula of xM₂/nO—Al₂O₃-ySiO₂-zH₂O. Here, M represents an ion-exchangeable metal, while n indicates the valence of this ion, where this ion is normally a monovalent or bivalent metal ion. On the other hand, x indicates the mol number of metal oxide, y indicates the mol number of silica, and z indicates the mol number of crystallization water. A specific example of silver zeolite is type-A silver zeolite, which is the most commonly used form of silver zeolite. The above antibacterial zeolite should have an average grain size of 0.1 μm to 20 μm, or preferably 0.4 μm to 9.0 μm, or more preferably 0.7 μm to 3.5 μm. The ion exchange capacity of type-A silver zeolite is 7 meq/g, which is sufficient to exchange applicable ions.

Note that type-A silver zeolite dried at 110° C. contains 16.8% of crystallization water before it is introduced to the extrusion machine. This type-A silver zeolite has a three-dimensionally bonded crystalline structure of Si—O—Al—O—Si where silver ions are electrostatically adsorbed to Al, and silver ions elute from the above crystalline structure due to ion exchange action to kill bacteria. The above skeleton of type-A silver zeolite contains 16.8% of water.

Polyethylene is introduced from the first hopper of the extrusion machine and melted, after which type-A silver zeolite is introduced into this molten polyethylene from the second hopper where it is kneaded, and finally the kneaded mixture is extruded and cooled and cut to pellets using a cutting knife to form an antibacterial water treatment agent. Since the above type-A silver zeolite containing 16.8% of crystallization water is heated to a temperature of 120 to 140° C., crystallization water contained in the above type-A silver zeolite evaporates during the above kneading process to form air bubbles, and these air bubbles are released from inside the above molten polyethylene to the outside during cooling. When the cooled mixture is cut to pellets using a cutting knife, continuous holes are formed to the surface of antibacterial water treatment agent.

(Type-A Silver Zeolite)

In forming continuous holes on polyethylene through evaporation of crystallization water in type-A silver zeolite, it is important that type-A silver zeolite contains crystallization water.

Industrial type-A silver zeolite products contain crystallization water, but the content of crystallization water varies depending on the drying conditions. Type-A silver zeolite dried at 110° C. contains 16.8% of crystallization water. Any type-A silver zeolite used in plastic pellets cannot be produced at a drying temperature lower than the melting temperature of the resin, because as mentioned, type-A silver zeolite containing crystallization water will generate steam and cause plastic pellets to turn white. For this reason, type-A silver zeolite dried at 250° C. or above where crystallization water does not have negative effect is used. If type-A silver zeolite is dried at 100° C. or less, crystallization water in it remains unstable, so it is preferable to use type-A silver zeolite dried at 110° C. Products using type-A silver zeolite include Zeomic AJ10N (by Sinanen Zeomic, having a silver ion support ratio of 2.2%).

Note that, although an antibacterial water treatment agent can also be produced using type X or Y silver zeolite, use of type X or Y silver zeolite is not preferable because a low content of crystallization water makes it difficult to form continuous holes.

(Polyethylene)

To form continuous holes in polyethylene (hereinafter referred to as “PE”) through evaporation of crystallization water in type-A silver zeolite, preferably the polyethylene should have an MFR in a range of 7 to 30 g per 10 minutes and melting point in a range of 120 to 140° C. Industrial type-A silver zeolite products dried at 110° C. contain 16.8% of crystallization water. To evaporate this crystallization water to form continuous holes to the surface of antibacterial water treatment agent, an MFR of less than 7 g per 10 minutes is not desirable because higher viscosity makes it difficult to form continuous holes. On the other hand, an MFR of more than 30 g per 10 minutes results in greater fluidity, meaning that even if steam holes are formed, they will disappear when agitated in the extrusion machine. If the melting temperature or melting point of PE is below 110° C., crystallization water in type-A silver zeolite will not be released. If the melting point is above 140° C., steam will become finer through agitation to make it difficult to form continuous holes.

It is therefore important that the MFR is in a range of 7 to 30 g per 10 minutes and the melting point is in a range of 120 to 140° C.

Note that, while polypropylene or polyethylene terephthalate can also be used to produce an antibacterial water treatment agent, these materials are not preferable in that formation of continuous holes will become difficult as crystallization water in type-A zeolite dried at 110° C. will be heated at a temperature above 140° C.

For PE, either LDPE or HDPE can be used as long as the MFR is within the above range. Examples of pellet form of LDPE include Novatec LD LJ8041 (by Japan Polypropylene) with an MFR of 23 g per 10 minutes and melting point of 123° C. Examples of powder form include Sunfine PAK F Type (by Asahi Kasei Chemicals) with an MFR of 10 g per 10 minutes and melting point of 125° C. Examples of HDPE include Nipolon Hard 1000 (by Tosoh) with an MFR of 20 g per 10 minutes and melting point of 134° C.

The content relationship of PE and type-A silver zeolite is determined by the application in which the antibacterial water treatment agent proposed by the present invention is used. If used in a storage tank of a water server, for example, the concentration of silver ions must be 40 to 100 ppb, while the PE content should preferably be in a range of 70 to 90%. If used in a drain pan of an air-conditioner, on the other hand, the above content should preferably be in a range of 60% to 80% because the longer the antibacterial action lasts, the better. An appropriate content should be selected according to the specific application.

(Antibacterial Water Treatment Agent)

As mentioned above, H₂O corresponding to 16.8% of crystallization water is bonded electrostatically to the skeleton of type-A silver zeolite, and in the extrusion process after kneading, this crystallization water is released as steam from the skeleton of the above type-A silver zeolite in PE to generate air bubbles, thereby forming continuous holes to the surface of antibacterial water treatment agent. To confirm that continuous holes were formed in antibacterial water treatment agent, a lateral cross-section and side face of a pellet of antibacterial water treatment agent were captured with an electron micrograph.

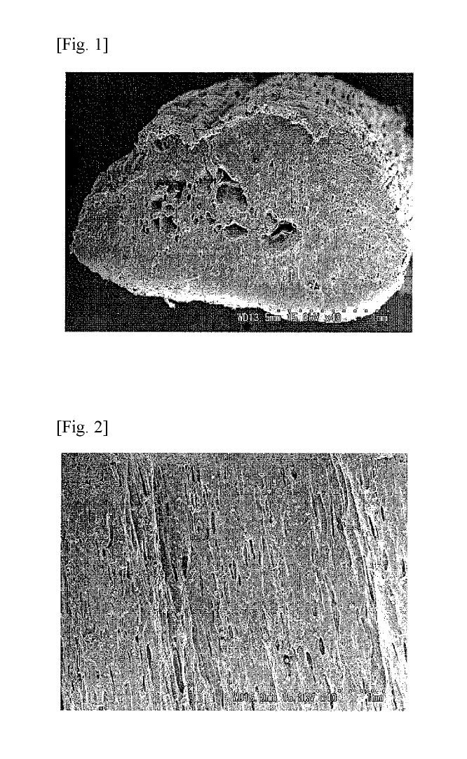

FIG. 1 is an electron micrograph of ×40 magnification, showing a lateral cross-section of a pellet of antibacterial water treatment agent.

FIG. 2 is an electron micrograph of ×40 magnification, showing a side face of a pellet of antibacterial water treatment agent.

The photograph in FIG. 1 shows many holes at the center; however, the steam generating near the center is not released to the outside but concentrates instead at the center to form large holes. In other locations, a countless number of very small holes are formed. The photograph in FIG. 2 shows a countless number of small, long holes extending in the vertical direction, formed by extrusion action from the outlet. These two photographs are proof that crystallization water is released as steam from the skeleton of type-A silver zeolite in PE to generate air bubbles, thereby forming a porous body having continuous holes to the surface of antibacterial water treatment agent.

For this reason, this antibacterial water treatment agent has a structure whereby, when it is immersed in water, water enters from all holes on its surface and travels through the continuous holes and consequently metal ions (calcium, potassium, sodium, etc.) in water come in contact with type-A silver zeolite to trigger ion exchange, thereby causing silver ions to dissociate from type-A silver zeolite and travel through the continuous holes to be released at the surface. In other words, this antibacterial water treatment agent is clearly a porous body having continuous holes formed on its surface from the skeleton of type-A silver zeolite.

However, the photograph in FIG. 2 shows small, long holes extending in the vertical direction, indicating that continuous holes are not formed to the surface of antibacterial water treatment agent from all parts of the skeleton of type-A silver zeolite. In other words, it is necessary to implement the acid treatment explained later on type-A silver zeolite contained in resin to dissolve type-A silver zeolite and generate silver ions, and measure the concentration of silver ions to quantify the amount of silver ions. To measure the concentration of silver ions, the high-frequency inductive coupling plasma emission analyzer explained below was used to measure the concentration of silver ions, and the measured concentration of silver ions was used to quantify the amount of silver ions.

(Measurement of Concentration of Silver Ions)

Although it is impossible to physically measure the amount of silver ions from type-A silver zeolite in plastic pellet form as mentioned above, the concentration of silver ions eluting in water can be measured to calculate the amount of silver ions from type-A silver zeolite. However, elution of silver ions takes a long time of 1 year or more, partly because ion exchange continuous in equilibrium over a long period, and partly because the concentration of silver ions varies depending on the conditions of metal ions in water (calcium, potassium, sodium, etc.), and consequently measuring the concentration of silver ions from type-A silver zeolite is difficult.

A solution to this problem is the measurement method for silver ion concentration proposed in Japanese Patent Laid-open No. 2008-1557. This measurement method for silver ion concentration focuses on the property of antibacterial zeolite constituting the plastic pellets containing silver ions, which property is that the aluminum component constituting this antibacterial zeolite is relatively vulnerable to acid; and utilizes the phenomenon that exchanged ions in this zeolite will dissolve in the liquid phase as a result of acid treatment. The above patent literature also states that when the concentration of silver ions in the obtained liquid phase was measured by the atomic absorption method and the silver ion concentration measured after acid treatment (measured value) was compared against the silver ion concentration calculated based on chemical theories (theoretical value), both values were roughly in agreement and thus it can be concluded that the concentration of silver ions from antibacterial zeolite can be measured based on acid treatment.

Based on the aforementioned measurement method for silver ion concentration based on acid treatment, nitric acid was used as the acid treatment agent to generate silver ions. To be specific, a nitric acid solution was formed by mixing 500 ml of water solution at 50° C. with HNO₃ having a specified concentration of 12 N (12 N (specified concentration)), and then the antibacterial water treatment agent in plastic pellet form was immersed in this nitric acid solution for 3 hours to generate silver ions by means of nitric acid treatment and the concentration of these silver ions was measured. This nitric acid treatment can generate silver ions over a very short period of 3 hours, and the concentration of these silver ions can be measured regardless of the conditions of metal ions in water (calcium, potassium, sodium, etc.). In addition, PE, which is a polyolefin resin, is not dissolved in the nitric acid solution.

As for the aforementioned type-A silver zeolite, the antibacterial agent contained in PE was explained as “type-A silver zeolite.” However, the type-A silver zeolite in powder form not contained in PE also refers to the same thing, and to prevent confusion with the amount of both silver ions obtained by measurement of concentration of silver ions from type-A silver zeolite, the type-A silver zeolite in powder form not contained in PE is hereinafter defined as “type-A silver zeolite powder” to differentiate it from the antibacterial type-A silver zeolite contained in PE.

(Glass Beads)

The porous antibacterial water treatment agent proposed by the present invention should preferably be precipitated in water to elute silver ions, because an attempt to immerse it in a storage tank of a water server, water tank or other water container will cause the porous agent to float on water, which makes it difficult to elute silver ions into water from the floating agent. To do this, glass beads must be contained in the antibacterial water treatment agent. By containing glass beads made of E glass not eluting in water, by 10 to 30% percent by weight in PE, the antibacterial water treatment agent can be caused to sink in water. EA-150 (by Nittobo) is an E glass bead product of solid sphere, having an average grain size of 10 to 20 μm and specific gravity of 2.6. For example, 20 percent by weight of glass beads can be blended into PE to adjust the apparent specific gravity to 1.24. By changing the blending ratio of glass beads, the specific gravity of the antibacterial water treatment agent, or how much it will sink in water, to be adjusted. The blending ratio of glass beads shall be in a range of 10 to 30 percent by weight. If glass beads are blended by more than 30 percent by weight, the specific gravity will be adjusted excessively. If glass beads are blended by less than 10 percent by weight, on the other hand, sufficient adjustment effect cannot be achieved.

### EXAMPLES

The following explains Example 1 to 3 of antibacterial water treatment agents whose silver support ratio in PE was adjusted to 0.5, 2.2 and 5.0%, respectively, each containing 20% of type-A silver zeolite.

### Example 1

In Example 1, Novatec LD L18041 (by Japan Polyethylene) being an LDPE, and Zeomic AW10N (by Sinanen Zeomic, having a silver support ratio 0.5%) being type-A silver zeolite dried at 110° C., were used.

The above LDPE had an MFR of 23 g per 10 minutes and melting point of 123° C., and was blended by 80%. Type-A silver zeolite was blended by 20%.

Pellets of the above LDPE and type-A silver zeolite were introduced to the hoppers of the extrusion machine. Thereafter, the above pellets and type-A silver zeolite were melted by the heating/cooling system of the extrusion machine at approx. 140° C. and kneaded, and eventually the kneaded mixture was extruded and cut to form an antibacterial water treatment agent. Through heating at approx. 140° C., the above zeolite containing 16.8% of crystallization water generated steam from type-A silver zeolite in LDPE as it was kneaded and extruded, and continuous holes were formed.

### Example 2

In Example 2, Novatec LD L18041 (by Japan Polyethylene) being an LDPE, and Zeomic AEON (by Sinanen Zeomic, having a silver support ratio 2.2%) being type-A silver zeolite dried at 110° C., were used.

The above LDPE had the same MFR and melting point and was blended by the same ratio as in Example 1. Similarly, type-A silver zeolite was blended by 20%. The forming method for antibacterial water treatment agent was also the same as in Example 1. Accordingly, their explanation is omitted.

### Example 3

In Example 3, Novatec LD L18041 (by Japan Polyethylene) being an LDPE, and Zeomic AK10N (by Sinanen Zeomic, having a silver support ratio 5.0%) being type-A silver zeolite dried at 110° C., were used.

The above LDPE had the same MFR and melting point and was blended by the same ratio as in Examples 1 and 2. Similarly, type-A silver zeolite was blended by 20%. The forming method for antibacterial water treatment agent was also the same as in Examples 1 and 2. Accordingly, their explanation is omitted.

### Comparative Example

In the comparative example, Novatec LD L18041 (by Japan Polyethylene) being an LDPE, and type-A silver zeolite of 2.5% in silver support ratio that has been dried at 250° C., were used. The above LDPE had the same MFR and melting point and was blended by the same ratio as in the examples. Similarly, type-A silver zeolite was blended by 20%.

Pellets of the above LDPE and type-A silver zeolite were introduced to the hoppers of the extrusion machine. Thereafter, the above pellets and type-A silver zeolite were melted by the heating/cooling system of the extrusion machine at approx. 140° C. and kneaded, and eventually the kneaded mixture was extruded and cut to form an antibacterial water treatment agent of the comparative example. Since the above type-A silver zeolite had been dried at 250° C., steam did not generate from type-A silver zeolite in LDPE even under heating at approx. 140° C., and accordingly, no continuous holes were formed to the surface of antibacterial water treatment agent in the comparative example, from type-A silver zeolite. This comparative example was prepared under the same conditions used by commercial products.

(Quantification of Amount of Silver Ions)

In the examples and comparative example, the amount of antibacterial water treatment agent was assumed to be 100 g in all cases to obtain the amount of silver ions, amount of acid dissolution silver ions and utilization ratio of silver ions as explained later, but in the measurement of concentration of acid dissolution silver ions, 2.5 g was used as the amount of antibacterial water treatment agent in all of the above examples and comparative example. To be specific, in the examples and comparative example, 2.5 g of antibacterial water treatment agent was immersed for 3 hours in 500 ml of HNO₃ (12 N (specified concentration)) solution at 50° C. to implement acid treatment, after which the concentration of silver ions dissolved by acid was measured using a high-frequency inductive coupling plasma emission analyzer (ICPS-8100 by Shimadzu Corporation).

The above analyzer can measure concentrations up to 10 ppm, but if the concentration exceeds 10 ppm, the measurement target must be diluted. This is why 2.5 g of each antibacterial water treatment agent was used as explained above.

The measured concentration of silver ions was used to calculate the amount of silver ions. Next, the ratio of the amount of silver ions calculated from the measured concentration of silver ions, to the amount of silver ions in type-A silver zeolite powder, was obtained as the utilization ratio of silver ions.

Table 1 summarizes the measured concentrations of acid dissolution silver ions, as well as the amounts of acid dissolution silver ions and utilization ratios of silver ions calculated from the measured concentrations.

The amount of silver ions in antibacterial water treatment agent, or A, indicates the weight of silver ions obtained via acid dissolution of type-A silver zeolite powder contained in 100 g of antibacterial water treatment agent (in mg per 100 g), while the concentration of acid dissolution silver ions represents the value measured by the high-frequency inductive coupling plasma emission analyzer (in ppm) mentioned above. The amount of acid dissolution silver ions, or B, indicates the value calculated from the measured value (in mg), while the utilization ratio of silver ions is obtained by dividing B, or the amount of silver ions obtained via acid dissolution of silver zeolite, by A, or the amount of silver ions from type-A silver zeolite powder (in %).

Note that in each of the examples and comparative example, the concentration of silver ions shown in Table 1 was obtained by measuring 3 samples and then calculating an arithmetic mean.

TABLE 1

| | | | | Amount of | | | |
|---|---|---|---|---|---|---|---|
| | | | | silver ions in | | | |
| | Silver zeolite | | | antibacterial | | Amount of acid | |
| | Silver | | | water treatment | Concentration of | dissolution | Utilization ratio |
| | support | | Content | agent A | acid dissolution | silver ions B | of silver ions (%) |
| | ratio (%) | Brand | (%) | (mg per 100 g) | silver ions (ppm) | (mg) | B/A × 100 |
| Example 1 | 0.5 | AW10N | 20 | 100 | 3.7 | 74.0 | 74.0 |
| Example 2 | 2.2 | AJ10N | 20 | 440 | 16.1 | 322.0 | 73.2 |
| Example 3 | 5.0 | AK10N | 20 | 1000 | 35.6 | 712.0 | 71.2 |
| Comparative | 2.5 | — | 20 | 500 | 1.4 | 28.0 | 5.6 |
| Example | | | | | | | |

Here, the reason why the amount of silver ions in 100 g of antibacterial water treatment agent containing type-A silver zeolite is different between Example 2 and the comparative example is explained. While both use Zeomic AJ10N by Sinanen Zeomic, the amount of silver ions is 440 mg with the former, but 500 mg with the latter. The reason for this difference is that, while the silver support ratio is 2.2% in Example 2, it is 2.5% in the comparative example, meaning that the amount of silver ions is 60 mg larger in the comparative example. In other words, although the weight of antibacterial water treatment agent containing type-A silver zeolite is the same at 100 g, type-A silver zeolite in Example 2 contains 16.8% of crystallization water after having been dried at 110° C., while type-A silver zeolite in the comparative example contains no crystallization water after having been dried at 250° C.

Next, an example of how to obtain the utilization ratio of silver ions is explained using Example 1.

The above amount of type-A silver zeolite in 100 g of antibacterial water treatment agent is calculated as 100 g×0.2=20 g, because 20% of the total weight of 100 g is type-A silver zeolite. Now, if 20 g of type-A silver zeolite powder is immersed for 3 hours in 500 ml of HNO₃ solution for acid treatment, the amount of acid dissolution silver ions is calculated as 20 g×0.005=0.1 g (100 mg) because the silver support ratio of this silver zeolite powder is 0.5%. However, in Example 1 the concentration of silver ions obtained by acid treatment of antibacterial water treatment agent is 3.7 ppm. And, because measurement was performed by assuming 2.5 g of this antibacterial water treatment agent, the amount of acid dissolution silver ions can be calculated from the silver ion concentration of 3.7 ppm, or 3.7 ppm×(500 ml/1000 ml)×(100 g/2.5 g), to arrive at 74.0 mg as the amount of acid dissolution silver ions obtained from 20 g of type-A silver zeolite.

Accordingly, while the amount of acid dissolution silver ions from 20 g of type-A silver zeolite powder is 100 mg, the amount of acid dissolution silver ions from antibacterial water treatment agent containing 20 g of type-A silver zeolite is 74.0 mg, which means that the utilization ratio of silver ions is 74.0 mg/100 mg×100=74.0%. The utilization ratio of silver ions can also be obtained under other examples and the comparative example using the aforementioned procedure.

From the amounts of acid dissolution ions and their utilization ratios in Table 1, the amounts of acid dissolution silver ions in the example are 12 times the amount in the comparative example, or specifically in the examples, silver ions of 13 times by amount of acid dissolution silver ions can be dissolved by acid. While the antibacterial water treatment agent in the comparative example wastes approx. 95% of expensive type-A silver zeolite, the antibacterial water treatment agents conforming to the present invention can effectively utilize at least 70% of type-A silver zeolite.

Next, the respective values shown in Table 1 are obtained for the antibacterial water treatment agents containing 10% and 30% of type-A silver zeolite in the same manner as with the antibacterial water treatment agent containing 20% of type-A silver zeolite (Examples 1 to 3). Here, a sample in Example 4 containing 10% of type-A silver zeolite at a silver support ratio of 0.5%, and that of Example 5 containing 30% of type-A silver zeolite at a silver support ratio of 5.0%, were prepared. In terms of the concentration of acid dissolution silver ions, amount of acid dissolution silver ions and utilization ratio of silver ions, the values of Example 4 represent the minimum, while those of Example 5 represent the maximum. Accordingly, minimum and maximum values were obtained from these two examples.

In Example 4, the sample was prepared in the same manner as in Example 1, except that the content of type-A silver zeolite was adjusted to 0.5%. In Example 5, the sample was prepared in the same manner as in Example 3, except that the content of type-A silver zeolite was adjusted to 5.0%.

Table 2 summarizes the measured concentrations of acid dissolution silver ions, as well as the amounts of acid dissolution silver ions and utilization ratios of silver ions calculated from the measured concentrations.

TABLE 2

| | | | | Amount of | | | |
|---|---|---|---|---|---|---|---|
| | | | | silver ions in | | | |
| | Silver zeolite | | | antibacterial | | Amount of acid | |
| | Silver | | | water treatment | Concentration of | dissolution | Utilization ratio |
| | support | | Content | agent A | acid dissolution | silver ions B | of silver ions (%) |
| | ratio (%) | Brand | (%) | (mg per 100 g) | silver ions (ppm) | (mg) | B/A × 100 |
| Example 4 | 0.5 | AW10N | 10 | 50 | 1.4 | 28.0 | 56.0 |
| Example 2 | 2.2 | AJ10N | 20 | 440 | 16.1 | 322.0 | 73.2 |
| Example 5 | 5.0 | AK10N | 30 | 1500 | 60.8 | 1216.0 | 81.1 |

The concentration of acid dissolution silver ions in Example 4 is 1.4 ppm, while the concentration of acid dissolution silver ions in Example 5 is 60.8 ppm. The amount of acid dissolution silver ions in Example 4 is 28.0 mg, while the amount of acid dissolution silver ions in Example 5 is 1216.0 mg. The utilization ratio of silver ions in Example 4 is 56.0%, while the utilization ratio of silver ions in Example 5 is 81.1%. Note that measured concentrations of acid dissolution silver ions are subject to an error of approx. ±5%. When this measurement error is considered, the concentrations of acid dissolution silver ions in the examples are in a range of 1.3 to 64 ppm, while the amounts of acid dissolution silver ions in the examples are in a range of 27 to 1277 mg, and the utilization ratios of silver ions in the antibacterial water treatment agents in the examples are in a range of 53 to 85%.

Also note that, while the amount of acid dissolution silver ions in the comparative example is 28.0 mg according to Table 1, the corresponding amount in Example 2 is 322.0 mg. Since the amount is 12 times that of the comparative example, a much larger amount of silver ions will elute compared to other commercial products containing the same amount of silver zeolite, and consequently the antibacterial action will last longer.

In the examples the concentrations of acid dissolution silver ions cover a wide range of 1.3 to 64 ppm, while also in the examples the amounts of acid dissolution silver ions cover a wide range of 27 to 1277 mg, and accordingly the antibacterial water treatment agent proposed by the present invention can be used in various applications such as water servers, water tanks, air-conditioners, washing tubs, drain mechanisms for sinks, drain piping facilities, water-based washing machines, and the like. In addition, while the amount of acid dissolution silver ions in the comparative example is 28.0 mg according to Table 1, the corresponding amount in Example 2 is 322.0 mg, which means that 12 times more silver ions will elute and thus the antibacterial action will last longer. Furthermore, the utilization ratios of silver ions in the antibacterial water treatment agents given by the examples cover a range of 53 to 85%, suggesting that expensive silver zeolite is utilized effectively to achieve greater economy.

Furthermore, Examples 7-4 to 7-6 of antibacterial water treatment agents containing glass beads are explained.

An antibacterial water treatment agent containing glass beads is formed by introducing polyethylene from the first hopper of the extrusion machine and melting the polyethylene, and then introducing type-A silver zeolite and glass beads from the second hopper to the molten polyethylene and kneading them together, after which the kneaded mixture is extruded and cooled and then eventually cut to pellets using a cutting knife.

To see how the concentration of acid dissolution silver ions, amount of acid dissolution silver ions and utilization of silver ions would vary when glass beads are contained, compared to antibacterial water treatment agents not containing glass beads, the concentration of acid dissolution silver ions and other values were also obtained in Examples 7-1 to 7-3 of antibacterial water treatment agents not containing glass beads.

Table 3 summarizes the measured concentrations of acid dissolution silver ions, as well as the amounts of acid dissolution silver ions and utilization ratios of silver ions calculated from the measured concentrations.

TABLE 3

| | | | | Amount of | | | |
|---|---|---|---|---|---|---|---|
| | | | | silver ions in | | | |
| | | | | antibacterial | | Amount of acid | |
| | Silver zeolite | | | water treatment | Concentration of | dissolution | Utilization ratio |
| | | Content | Glass bead | agent A | acid dissolution | silver ions B | of silver ions (%) |
| | Brand | (%) | content (%) | (mg per 100 g) | silver ions (ppm) | (mg) | B/A × 100 |
| Example 7-1 | AW10N | 30 | 0 | 150 | 4.2 | 84.0 | 56.0 |
| Example 7-2 | AJ10N | 20 | 0 | 440 | 16.1 | 322.0 | 73.2 |
| Example 7-3 | AK10N | 10 | 0 | 500 | 20.3 | 405.5 | 81.1 |
| Example 7-4 | AW10N | 30 | 10 | 150 | 4.2 | 84.0 | 56.0 |
| Example 7-5 | AJ10N | 20 | 20 | 440 | 15.1 | 302.0 | 68.6 |
| Example 7-6 | AK10N | 10 | 30 | 500 | 18.3 | 366.5 | 73.3 |

As can be seen, when the glass bead content increases from 10% to 30%, the utilization ratio of silver ions drops even though the amount of silver ions A remains the same. This suggests that when glass beads are contained, formation of continuous holes is hindered.

The present application claims priority to Japanese Patent Application No. 2010-273186, filed Dec. 8, 2010, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

1. An antibacterial water treatment agent constituted by polyethylene containing silver zeolite, wherein the silver zeolite has a type-A crystalline structure and is contained in a range of 10 to 30 percent by weight of the antibacterial water treatment, and the antibacterial water treatment agent is a porous body having continuous holes formed from the silver zeolite to the surface of the porous body, said continuous holes in the porous body being tracks of vaporized crystallization water contained in the above silver zeolite.

2. An antibacterial water treatment agent according to claim 1, wherein a MFR (Melt Flow Rate) of the aforementioned polyethylene is in a range of 7 to 30 g per 10 minutes and that its melting point is in a range of 120 to 140° C.

3. An antibacterial water treatment agent according to claim 1, wherein a silver support ratio of the aforementioned silver zeolite is in a range of 0.5 to 5.0% by weight.

4. An antibacterial water treatment agent according to claim 3, wherein the aforementioned polyethylene is low-density polyethylene or high-density polyethylene.

5. An antibacterial water treatment agent according to claim 4, wherein the total concentration of silver ions produced via nitric acid dissolution from silver zeolite contained in 100 g of the antibacterial water treatment is in a range of 1.3 to 64 ppm.

6. An antibacterial water treatment agent according to claim 4, wherein the total amount of silver ions produced via nitric acid dissolution from silver zeolite contained in 100 g of the antibacterial water treatment is in a range of 27 to 1277 mg.

7. An antibacterial water treatment agent according to claim 4, wherein a utilization ratio of silver ions, which is a ratio calculated by dividing the total amount of silver ions produced via nitric acid dissolution from silver zeolite contained in 100 g of the antibacterial water treatment, by the total amount of silver ions produced via nitric acid dissolution from a type-A silver zeolite powder of the same amount as the aforesaid silver zeolite, is in a range of 53 to 85%.

8. An antibacterial water treatment agent according to claim 1, wherein the antibacterial water treatment agent further comprises glass beads in a range of 10 to 30 percent by weight.

9. An antibacterial water treatment agent according to claim 2, wherein a silver support ratio of the silver zeolite is in a range of 0.5 to 5.0% by weight.

10. An antibacterial water treatment agent according to claim 9, wherein the aforementioned polyethylene is low-density polyethylene or high-density polyethylene.

11. An antibacterial water treatment agent according to claim 10, wherein the total concentration of silver ions produced via nitric acid dissolution from silver zeolite contained in 100 g of the antibacterial water treatment is in a range of 1.3 to 64 ppm.

12. An antibacterial water treatment agent according to claim 10, wherein the total amount of silver ions produced via nitric acid dissolution from silver zeolite contained in 100 g of the antibacterial water treatment is in a range of 27 to 1277 mg.

13. An antibacterial water treatment agent according to claim 10, wherein a utilization ratio of silver ions, which is a ratio calculated by dividing the total amount of silver ions produced via nitric acid dissolution from silver zeolite contained in 100 g of the antibacterial water treatment, by the total amount of silver ions produced via nitric acid dissolution from a type-A silver zeolite powder of the same amount as the aforesaid silver zeolite, is in a range of 53 to 85%.

14. An antibacterial water treatment agent according to claim 2, wherein the antibacterial water treatment agent further comprises glass beads in a range of 10 to 30 percent by weight.

15. An antibacterial water treatment agent according to claim 3, wherein the antibacterial water treatment agent further comprises glass beads in a range of 10 to 30 percent by weight.

16. An antibacterial water treatment agent according to claim 4, wherein the antibacterial water treatment agent further comprises glass beads in a range of 10 to 30 percent by weight.

17. An antibacterial water treatment agent according to claim 5, wherein the antibacterial water treatment agent further comprises glass beads in a range of 10 to 30 percent by weight.

18. An antibacterial water treatment agent according to claim 6, wherein the antibacterial water treatment agent further comprises glass beads in a range of 10 to 30 percent by weight.

19. An antibacterial water treatment agent according to claim 7, wherein the antibacterial water treatment agent further comprises glass beads in a range of 10 to 30 percent by weight.
